(19) United States
(12) Patent Application Publication
(10) Pub. No.: US 2022/0121408 A1
(43) Pub. Date: Apr. 21, 2022

(54) CONTENT PRESENTATION CONTROL DEVICE, PRESENTATION CONTROL METHOD, AND NON-TRANSITORY COMPUTER-READABLE STORAGE MEDIUM

(71) Applicants: DENSO CORPORATION, Kariya-city (JP); TOYOTA JIDOSHA KABUSHIKI KAISHA, Toyota-shi (JP)

(72) Inventors: Daiki KAWASHIMA, Kariya-city (JP); Shigeo KATOH, Kariya-city (JP); Kentaro TESHIMA, Kariya-city (JP); Rio MIZUNO, Aichi-gun (JP); Kazuya OHTAKE, Toyota-city (JP); Hiroshi MAJIMA, Kobe-city (JP); Kazuki SASAMOTO, Chita-gun (JP)

(21) Appl. No.: 17/562,621

(22) Filed: Dec. 27, 2021

Related U.S. Application Data
(63) Continuation of application No. PCT/JP2020/025334, filed on Jun. 26, 2020.

(30) Foreign Application Priority Data
Jul. 2, 2019 (JP) 2019-123646

(51) Int. Cl. G06F 3/14

(52) U.S. Cl. CPC G06F 3/14

(57) ABSTRACT

A state of an external device is acquired. It is arbitrated which content is preferentially presented, based on a rule definition including a constraint equation according to a presentation request of the content obtained from an application and the state of the external device acquired in the acquiring of the state. A presentation of the content is controlled according to an arbitration result performed in the arbitrating.

### CROSS REFERENCE TO RELATED APPLICATION

The present application is a continuation application of International Patent Application No. PCT/JP2020/025334 filed on Jun. 26, 2020, which designated the U.S. and claims the benefit of priority from Japanese Patent Application No. 2019-123646 filed on Jul. 2, 2019. The entire disclosures of all of the above applications are incorporated herein by reference.

### TECHNICAL FIELD

The present disclosure relates to a content presentation control device, a presentation control method, and a non-transitory computer-readable storage medium.

### BACKGROUND

For example, the content displayed on the display device installed in the vehicle and the content output from the sound output device are a variety of features. Examples of this type of content include a content of the travelling system related to vehicle running, a content of the non-travelling system not related to vehicle running, and the like. Examples of the content of the traveling system include vehicle speed, engine speed, shift position, remaining amount of fuel, and the like. Examples of the content of the non-travelling system include map information for navigation, audio information, telephone information, and the like.

### SUMMARY

According to an example, a state of an external device is acquired. It is arbitrated which content is preferentially presented, based on a rule definition including a constraint equation according to a presentation request of the content obtained from an application and the state of the external device acquired in the acquiring of the state. A presentation of the content is controlled according to an arbitration result performed in the arbitrating.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a functional block diagram showing a configuration of a presentation control system according to an embodiment;

FIG. 2 is a diagram showing priority arbitration;

FIG. 3 is a diagram showing a latter-content-win arbitration;

FIG. 4 is a diagram showing the relationship between the Z-order of an area and the priority;

FIG. 5 is a diagram showing the relationship between a content, a state, and an area;

FIG. 6 is a diagram showing the syntax of a predicate logic expression;

FIG. 7 is a flowchart showing the entire processing of the arbitration logic;

FIG. 8 is a flowchart showing a control execution process;

FIG. 9 is a diagram showing a communication interface when no property is defined;

FIG. 10 is a diagram showing a communication interface when defining a property;

FIG. 11 is a diagram showing a rule definition when a property is not defined;

FIG. 12 is a diagram showing a rule definition when defining a property;

FIG. 13 is a diagram showing a mode in which a signal is transmitted/received when a property is not defined; and

FIG. 14 is a diagram showing a mode in which a signal is transmitted/received when defining a property.

### DETAILED DESCRIPTION

Content is presented in response to a content presentation request from the application. That is, the display content is displayed in response to a display request from the application, and the voice output content is output in response to a voice output request from the application. In this case, when a content presentation request is generated from another application while the content of one application is being presented, arbitration is performed as to which content is to be presented with priority. For example, conceivable technique teaches a method of arbitrating which content is presented with priority.

When the content presentation control device receives the presentation stop command from the external device during the content presentation, the content presentation is stopped. For example, when the content presentation control device is a multimedia device (hereinafter referred to as MM device) and the external device is a meter device, the meter device transmits a stop command of the content presentation to the MM device when a request for presenting the content of the alarm voice output occurs. When the MM device receives the presentation stop command from the meter device during the presentation of the content, regardless of the reason why the meter device sends the presentation stop command, and regardless of what kind of state the MM device is, the MM device stops presenting the content.

In such a configuration in which the content presentation control device uniformly stops the content presentation, the content that has a higher priority than the others in the entire system including the content presentation control device and the external device is not presented, so that there may be concern that the content with a lower priority than others will be presented preferentially.

In view of the above points, priority is appropriately given to the content having a higher priority than others in the entire system including the content presentation control device and the external device.

According to one feature of the present embodiments, the application storage unit can store the application that generates the content presentation request. The rule definition storage unit stores the rule definition including the constraint equation. The state acquisition unit acquires the state of the external device. The arbitration unit arbitrates which content is preferentially presented, based on the rule definition stored in the rule definition storage unit according to the content presentation request from the application and the state of the external device acquired by the state acquisition unit. The presentation control unit controls the presentation of the content according to the arbitration result performed by the arbitration unit.

Regarding the content presentation request from the application and the state of the external device, arbitration is performed as to which content is to be presented with priority based on the rule definition. Rather than arbitrating which content is presented with priority by itself, the content presentation control device and the external device cooperate with each other to perform arbitration to cross over between the content presentation control device and the external device, so that the content that has a higher priority than others in the entire system including the content presentation control device and the external device is presented with appropriate priority.

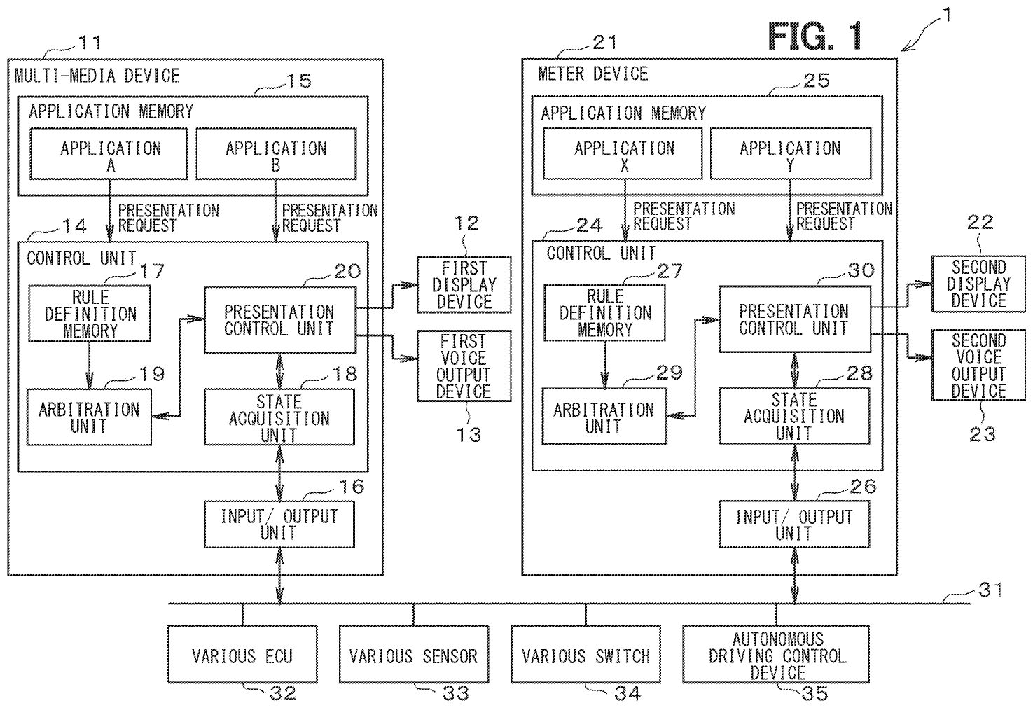

The following will describe an embodiment of the present disclosure with reference to the accompanying drawings. As shown in FIG. 1, in the presentation control system 1, a multimedia device (hereinafter, MM device) 11 (corresponding to a content presentation control device) and a meter device 21 (corresponding to an external device) are connected to each other via an in-vehicle network 31 so that data communication is possible. The in-vehicle network 31 is, for example, CAN (Controller Area Network, registered trademark) or the like. The MM device 11 and the meter device 21 are connected to various ECUs 32, various sensors 33, various switches 34, an automatic driving control device 35, and the like via an in-vehicle network 31.

The first display device 12 and the first audio output device 13 are connected to the multimedia device 11. The first display device 12 is, for example, a display including a full-color liquid crystal display device, and basically functions as a display unit for displaying non power train content that is not related to vehicle traveling. The non power train content includes, for example, map information for navigation, audio information, telephone information, and the like. The first audio output device 13 includes one or a plurality of speakers, and functions as an audio output unit that outputs audio of non-traveling content. The second display device 22 and the second audio output device 23 are connected to the meter device 21. The second display device 22 is, for example, a display including a full-color liquid crystal display device, and basically functions as a display unit for displaying power train content that is related to vehicle traveling. The content of the power train is, for example, vehicle speed, engine speed, shift position, remaining amount of fuel, and the like. The second audio output device 23 includes one or a plurality of speakers, and functions as an audio output unit that outputs audio of the content of the traveling system. The content is displayed on each of the display devices 12 and 22, and the content is output by each of the voice output devices 13, 23, so that various information including the content of the traveling system and the content of the non-traveling system can be presented to the passenger.

The MM device 11 has a control unit 14, an application storage unit 15, and input/output I/F 16. A plurality of applications A to B are stored in advance in the application storage unit 15. When one or more content presentation requests are generated, the applications A to B interrupt and output a presentation request indicating the presentation target, the area, the zone, and the content to the control unit 14. That is, when the content display request to the first display device 12 is generated, each of the applications A to B interrupts and outputs a presentation request indicating the display target, the area, and the content to the control unit 14. The area is a region allocated when displaying the content. Further, when the content audio output request to the first voice output device 13 is generated, each of the applications A to B interrupts and outputs a presentation request indicating the audio output target, the zone, and the content to the control unit 14. The zone is an area allocated when the content is output as audio. The control unit 14 has a microcomputer including a CPU (Central

Processing Unit), a ROM (Read Only Memory), a RAM (Random Access Memory), an I/O (Input/Output), and the like, and executes a program stored in a non-transitory tangible storage medium to control the operation of the MM device 11. The control unit 14 includes a rule definition storage unit 17, a state acquisition unit 18, an arbitration unit 19, and a presentation control unit 20.

The rule definition is stored in the rule definition storage unit 17. The rule definition includes an arbitration policy that defines basic arbitration when assigning a content to an area or a zone, and a constraint expression. The arbitration policy is always set by any of priority arbitration, latter content win arbitration, and value-based arbitration, as will be described later. The constraint expression may not be limited to one, and may not be provided or may be provided with a plurality of equations according to the intention of the writer.

The state acquisition unit 18 acquires the state of the meter device 21 from the meter device 21 via the in-vehicle network 31 and the input/output I/F 16. The arbitration unit 19 arbitrates the content to be allocated to the presentation area based on the rule definition stored in the rule definition storage unit 17. The arbitration unit 19 may interrupt and output presentation requests at the same time from a plurality of different applications. In such a case, the arbitration unit 16 arbitrates which content is to be presented with priority. “Simultaneous” here may not mean at the same time in chronological time, alternatively, may mean a state in which a content presentation request is generated from another application while one application is presenting the content, that is, two or more applications interrupt and output presentation requests at the same time. When the content is arbitrated by the arbitration unit 19, the presentation control unit 20 displays the content assigned by the arbitration in a predetermined area or outputs a voice from the predetermined zone.

The meter device 21 has basically the same configuration as the MM device 11, and has a control unit 24, an application storage unit 25, and an input/output I/F 26. A plurality of applications X to Y are stored in advance in the application storage unit 25. When one or more content presentation requests are generated, the applications X to Y interrupt and output a presentation request indicating the presentation target, the area, the zone, and the content to the control unit 24. That is, when the content display request to the second display device 22 is generated, each of the applications X to Y interrupts and outputs a presentation request indicating the display target, the area, and the content to the control unit 24. Further, when the content audio output request to the second voice output device 23 is generated, each of the applications X to Y interrupts and outputs a presentation request indicating the audio output target, the zone, and the content to the control unit 24.

The control unit 24 has a microcomputer including a CPU, ROM, RAM, I/O, and the like, executes a presentation control program stored in a non-transitory tangible storage medium, and controls the operation of the meter device 21. The control unit 24 includes a rule definition storage unit 27, a state acquisition unit 28, an arbitration unit 29, and a presentation control unit 30. The rule definition is stored in the rule definition storage unit 27. The rule definition includes an arbitration policy that defines basic arbitration when assigning a content to an area or a zone, and a constraint expression. The arbitration policy is always set by any of priority arbitration, latter content win arbitration, and value-based arbitration, as will be described later. The constraint expression may not be limited to one, and may not be provided or may be provided with a plurality of equations according to the intention of the writer.

The state acquisition unit 28 acquires the state of the MM device 11 from the MM device 11 via the in-vehicle network 31 and the input/output I/F 26. The arbitration unit 29 arbitrates the content to be allocated to the presentation area based on the rule definition stored in the rule definition storage unit 27. The arbitration unit 29 may interrupt and output presentation requests at the same time from a plurality of different applications. In such a case, the arbitration unit 16 arbitrates which content is to be presented with priority. “Simultaneous” here may not mean at the same time in chronological time, alternatively, may mean a state in which a content presentation request is generated from another application while one application is presenting the content, that is, two or more applications interrupt and output presentation requests at the same time. When the content is arbitrated by the arbitration unit 29, the presentation control unit 30 displays the content assigned by the arbitration in a predetermined area or outputs a voice from the predetermined zone.

The rule-based arbitration will be described below. Here, the case where the content is displayed in the area will be described, similarly, the basic idea is the same for the case where the content is output as audio from the zone.

### (1) Rule-Based Arbitration

The rule-based arbitration describes an arbitration method in which the content is arbitrated and allocated to an arbitrary area based on a predetermined rule. Area definitions, content definitions, and constraint expressions are required as rule definitions in rule-based arbitration.

### (1-1) Area Definition

The area definition defines the display location, the value of the display location, and the arbitration policy. Since arbitration is performed for each area, an arbitration policy is defined for each area.

In the area, a frame for displaying the content on the display screens of the display devices 12 and 22 is defined. Only one content is assigned to an area.

Area is defined as follows.

The area displays the allocated content.

The area has an arbitration policy.

The area refers to the content that can be displayed.

The area has one or more sizes.

Each area has properties. The priority, Z-order, arbitration policy, and size are set as properties.

### (A) Priority

The priority is a value (in a range between 0% and 100%) indicating the value of the area itself. The arbitration is performed in order from the area with the highest priority value.

### (B) Z Order

The Z-order is a coordinate with respect to a height. The higher the Z-order value, the more it is displayed on the front side. When there are areas with the same priority, arbitration is performed in descending order of Z-order value.

### (C) Arbitration Policy

The arbitration policy is one of priority arbitration, latter win arbitration, and value-based arbitration.

### (C-1) Priority Arbitration

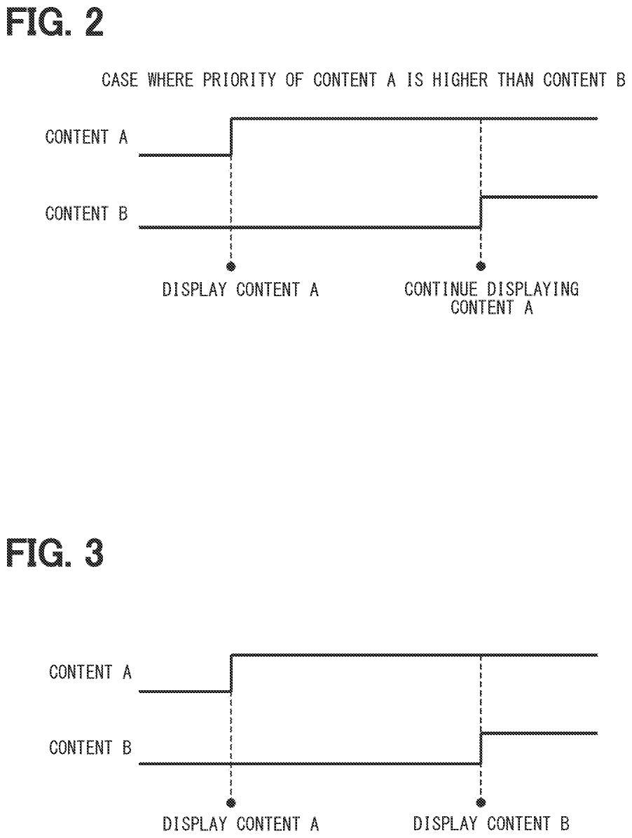

The priority arbitration is an arbitration policy for each area, and as shown in FIG. 2, it is arbitration that displays the content having the highest priority among the contents that can be displayed in the area.

### (C-2) Latter Win Arbitration

The latter win arbitration is an area-based arbitration policy. As shown in FIG. 3, the content of the last request in the area is displayed, and when the display of the last request content is finished, the second last request among the remaining contents is displayed.

### (C-3) Value-Based Mediation

Value-based arbitration is an arbitration policy for the entire area, and is arbitration that displays the content that maximizes the calculated value obtained by multiplying the numerical value that quantifies the value of the content and the numerical value that quantifies the value of the area.

### (D) Size

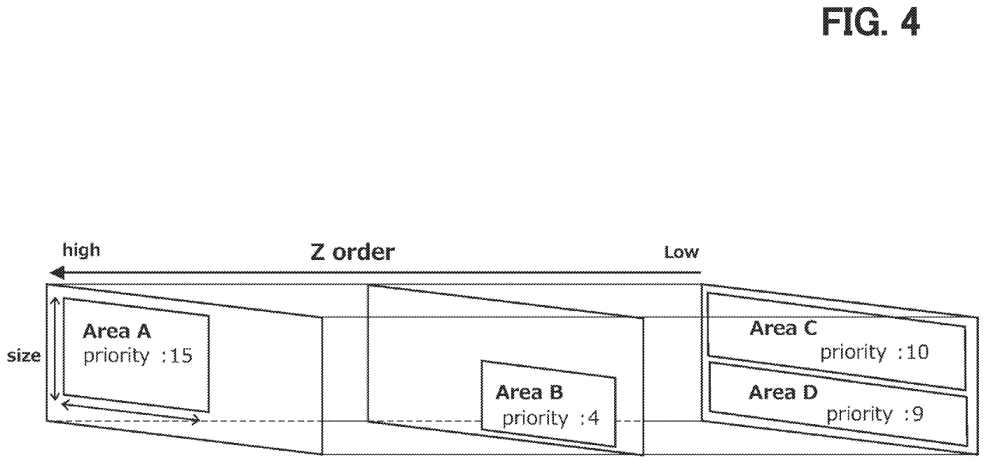

The size is the size of the area, which is defined by a vertical size x a horizontal size. When more than one sizes are defined, it is determined according to the size of the content. The relationship between the Z-order of the area and the priority is shown in FIG. 4.

### (1-2) Content Definition

The content definition defines the displayable area, the state of the content, and the value of the state of the content. The content can have multiple states, the content is assigned to the area, and the content status is displayed. The content defines and refers to the area in which the content itself can be displayed.

In the content, the content to be displayed in the area defined on the display screens of the display devices 12 and 22 is defined. Only one content is assigned to an area.

Content is defined as follows.

Content is assigned to the area.

The content refers to one or more areas in which the content itself can be displayed.

The content always has one or more states.

Content has one or more sizes.

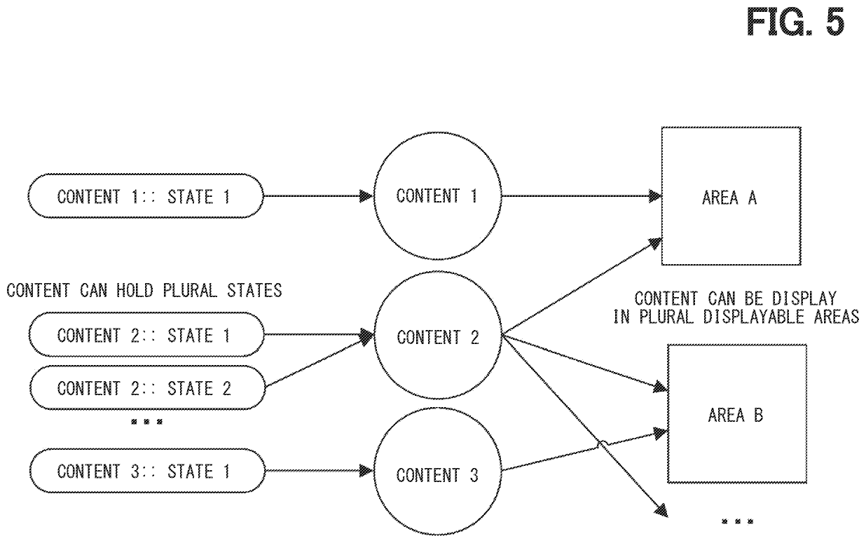

When there are a plurality of displayable areas, the content can be displayable in any one of areas, and one content can be displayed in a plurality of areas at the same time. One content can have a plurality of states, and when a plurality of states are held, each state is exclusive and can always be displayed only in one state at a time. The content can have multiple sizes, and when there are multiple sizes, the closest size is displayed according to the size of the display target area. The relationship between a content, a state, and an area is linked as shown in FIG. 5.

The content has a property, and the property is set with an attribute indicating the priority, the size, the feature whether the presentation request is withdrawn (i.e., cancelled) or not withdrawn (i.e., on standby) when the content loses the arbitration.

### (A) Priority

The priority is a value used when the arbitration policy of the area is “priority arbitration”, and the content having a high priority is assigned to the area first.

### (B) Size

The size is the display size of the content and is defined by a vertical size x a horizontal size. When more than one sizes are defined, it is determined according to the size of the area.

### (1-3) Constraint Equation

A constraint equation is a rule that describes the properties that must be exceptionally satisfied during or after arbitration. By suppressing the state of arbitration with a constraint equation, it is possible to express a state that cannot be expressed by the arbitration policy as it is, or to use it for determining the arbitration result after arbitration. That is, for example, depending on the situation such as the running state of the vehicle, it may be better not to display even the content assigned by the arbitration policy. The constraint equation defines the conditions for content suppression and area suppression, which are the conditions that the arbitration result must satisfy.

The logical equation that can be handled by the constraint equation are the content state, the area state, the content being displayed in the area, the set of the area and the content, the scene state, the logical operation, and the quantification symbol. The scene is, for example, a manual driving scene or an automatic driving scene by the autonomous driving device 35, and display control is possible in which the content of the manual driving content group is not displayed in the autonomous driving scene.

(A) The content state is either active/inactive or displayed/hidden.

(B) The state of the area is either displayed or hidden.

(C) The logical operations are NOT (!), AND, OR, implication (->), and equal sign (=).

The quantification symbol includes ∀ (For all: the condition is satisfied for all elements of the set) and ∃ (Exists: at least one element satisfying the condition exists in the set)

### (D) Constraint Equation

The constraint equation affects the result of the arbitration logic, and the arbitration logic i set to satisfy all constraints.

### (1-4) Content Suppression

For example, “central area.displaying Content ( )=c1->! C2.is Visible ( )” is exemplified as a constraint equation that the content c2 is not displayed while the content c1 is being displayed. This constraint equation describes the suppression that the content c2 is not displayed when the content c1 is being displayed in the central area.

### (1-5) Priority Arbitration and Latter Win Arbitration

When priority arbitration and latter win arbitration coexist, it is possible to handle them by setting the arbitration policy of the area to the latter win policy and by describing only the relationship between the contents related to the priority with a constraint equation.

As such a constraint equation, “telephone.is Active ( )->For All MM type interrupt (other than telephone) {x|! X.is Visible ( )}” is illustrated. The arbitration policy is the area of the latter win arbitration, and describes the suppression that all multimedia type interrupts (other than the telephone) are not displayed when the content with the high priority, i.e., the telephone, is active by adding this constraint equation.

### (2) Arbitration Logic

The arbitration logic is an algorithm that defines how to allocate the content to satisfy a constraint equation based on an area arbitration policy according to a predetermined rule. Basically, the arbitration is performed in order of priority for each area. The arbitration logic includes arbitration within the area and arbitration for the entire area.

(2-1) Arbitration in the Area

(A) For arbitration within the area, the areas in the priority arbitration and the latter win arbitration are arbitrated in descending order of priority.

(B) Evaluate the following feature for each area.

Temporarily assign the highest priority content, and when the evaluation result of the constraint equation is true (TRUE), determine the temporarily assigned content. When the evaluation result of the constraint equation is false (FALSE), the next highest priority content is re-evaluated. When there is no content that satisfies the constraint equation, no content is displayed in that area.

### (2-2) Arbitration of the Entire Area

The arbitration (i.e., value-based arbitration) for the entire area includes best fit logic and one pass logic.

(A) The best fit logic selects the highest total value among all the combinations of the contents satisfying the constraint equation and the areas.

(B) The one-pass logic assigns the content with the highest priority to the area in order from the area with the higher priority, and excludes the content already assigned to the other area. In this embodiment, the one-pass logic is adopted, alternatively, the best-fit logic may be adopted.

In the conceivable rule-based arbitration, arbitration is performed within the device, but arbitration is not performed between the two devices in cooperation with each other. Therefore, between the MM device 11 and the meter device 21, the meter device 21 transmits, for example, a content presentation stop command to the MM device 11 when a request for presenting the content of the alarm sound output occurs. When the MM device 11 receives the presentation stop command of the content from the meter device 21 during the presentation of the content, regardless of the reason why the meter device 21 sends the presentation stop command, and regardless of what kind of state the MM device is, the MM device 11 stops presenting the content. However, in such a configuration, there is a difficulty that the content having a higher priority than the others in the entire system of the presentation control system 1 may not be presented, and the content having a lower priority than the others may be presented preferentially. Under these circumstances, the following configuration is adopted in this embodiment.

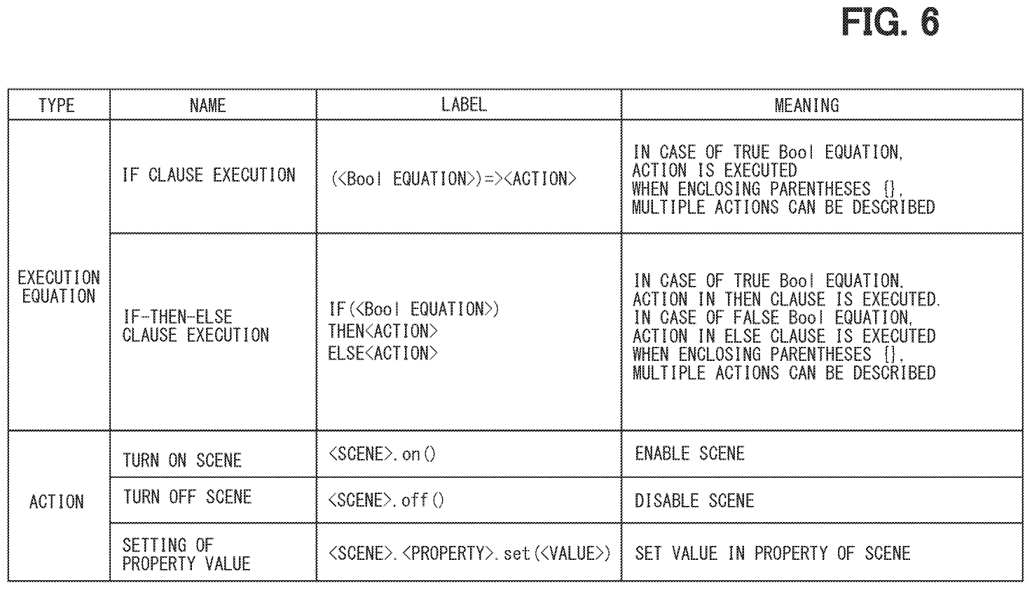

In the presentation control system 1, the MM device 11 and the meter device 21 use the syntax of the predicate logic equation for the MM device 11 and the meter device 21 to cooperate with each other to perform arbitration, as shown in FIG. 6. “IF execution equation” means to execute an action when the Bool equation is true (i.e., TRUE). “IF-THEN-ELSE execution equation” means to execute the action of the then-clause when the Bool equation is true, and to execute the action of the else-clause when the Bool equation is false (i.e., FALSE). “Scene on” means to enable the scene. “Scene off” means disabling the scene. “Setting property values” means setting values for the properties of the scene. The arbitration units 19 and 29 execute the control execution equation after confirming the result in the arbitration process. Hereinafter, the overall processing of the arbitration logic and the control execution processing performed by the arbitration units 19 and 29 will be described.

### (1) Overall Processing of Arbitration Logic

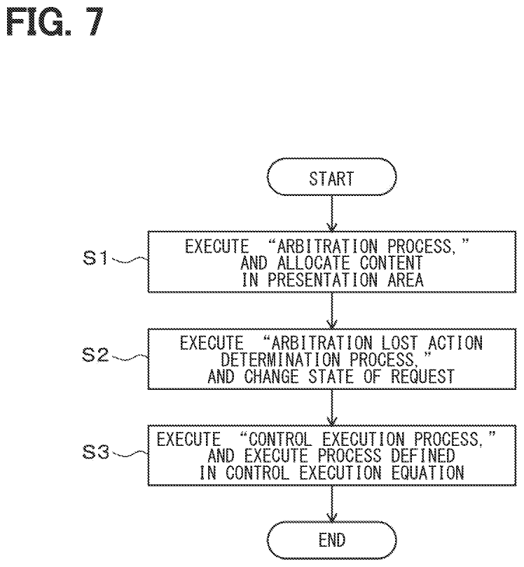

As shown in FIG. 7, the arbitration units 19, 29 perform the entire processing of the arbitration logic. When the arbitration units 19 and 29 receive a presentation request from another application while presenting the content of one application, the arbitration unit performs arbitration processing and allocates the content to the presentation area (at S1). The arbitration units 19 and 29 perform the action determination process at the time of losing, determine whether the content that lost the arbitration is on standby or cancels, and changes the state of the request (at S2). That is, the arbitration unit 19, 29 determines whether or not it is necessary to change “a standby mode” to “a cancel mode,” and when it determines that it is not necessary to change, it remains “a standby mode” and when it determines that it is necessary to change, it changes from “a standby mode” to “a cancel mode”. The arbitration units 19 and 29 perform the control execution process and execute the process defined by the control execution equation (at S3).

### (2) Control Execution Processing

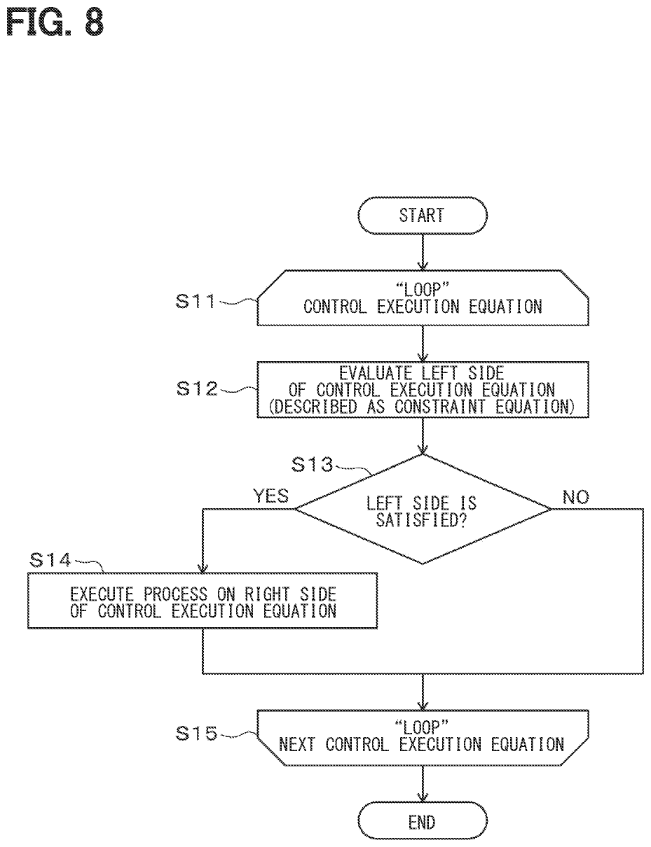

As shown in FIG. 8, the arbitration units 19 and 29 perform control execution processing and determine whether or not there is a control execution equation (at S11). When the arbitration units 19 and 29 determine that there is no control execution equation, the loop ends. When the arbitration units 19 and 29 determine that there is a control execution equation, they evaluate the left side of the control execution equation (at S12) and determine the evaluation result (at S13). When the arbitration units 19 and 29 determine that the evaluation result is “TRUE” and satisfy the left side (“YES” at S13), the arbitration units 19 and 29 execute the processing of the right side of the control execution equation (at S14). When the arbitration units 19 and 29 determine that the evaluation result is “FALSE” and do not satisfy the left side (“NO” at S13), the arbitration units 19 and 29 do not execute the processing on the right side of the control execution equation. The arbitration units 19 and 29 repeat the above-mentioned processing for the next control execution equation (at S15).

When the MM device 11 and the meter device 21 cooperate with each other to perform arbitration between them, scene information is transmitted and received. The scene information has two states, that are an on state and an off state, and the constraint equation can be described therein to arbitrated on the condition of the scene information. For example, the information receiving side can describe a constraint equation that, when the scene information is in the on state, it attenuates its own fundamental voice.

(Example 1) The constraint equation of “Attenuate the fundamental voice when the pre-crash warning voice is sounding” is:

{PCS.isOn( )->Base.isAttenuated( )}.

Further, the information transmitting side can describe the conditions for turning on the scene information and notifying the scene information.

(Example 2) The constraint equation of “notify that the pre-crash warning voice is in the on state while the pre-crash warning is being output” is:

{PCS alarm.isSounding ( )=>PCS.on ( )}.

In addition, property information can be arbitrarily defined in the scene information. The property information has a title and sets a value (that is an integer). Multiple property information can be set for one scene. By defining the property information, the receiving side of the scene information can abstractly express the rule by using the value of the property information for the condition determination of the threshold value and the like.

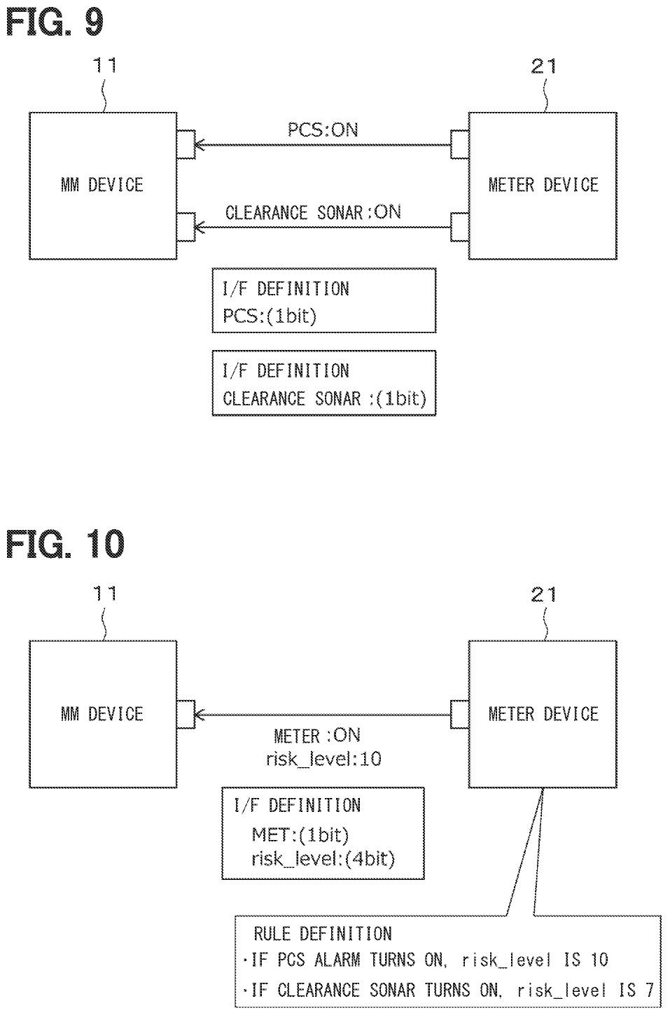

When sending and receiving scene information, it is necessary to define a communication interface between devices. When the property information is not defined, as shown in FIG. 9, the pre-crash warning sound has two states, that are on and off, so the signal “PCS: (1 bit)” is defined. Similarly, since the clearance sonar alarm sound has two states, that are the on state and the off state, the signal “clearance sonar: (1 bit)” is defined. On the other hand, when defining the property information, as shown in FIG. 10, the signal “MET: (1 bit) risk_level: (4 bit)” is defined. In this case, the meter device 21 defines, for example, “risk_level is 10 if the pre-crash alarm is on” and “risk_level is 7 if the clearance sonar alarm is on” in the rule definition. By defining property information, various scenes can be expressed, and it is possible to prevent an increase in software development man-hours while suppressing the frequency of changing the communication interface between devices.

Next, the arbitration performed by the MM device 11 and the meter device 21 in cooperation with each other will be described. Here, in the MM device 11, application A is used as the fundamental voice, application B is used as the interrupt voice, and application X is used as the meter sound in the meter device 21.

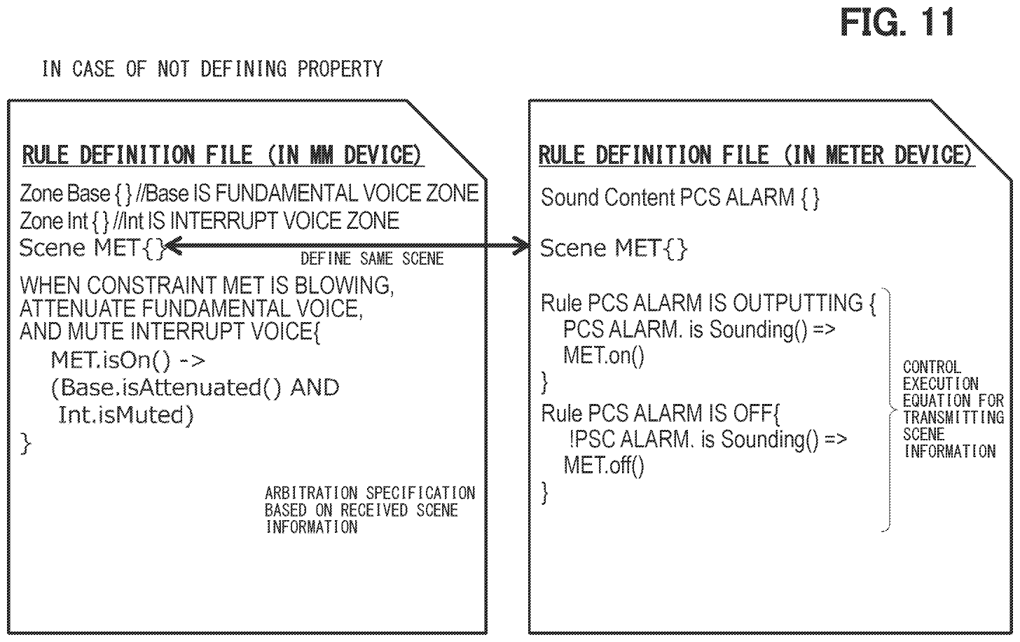

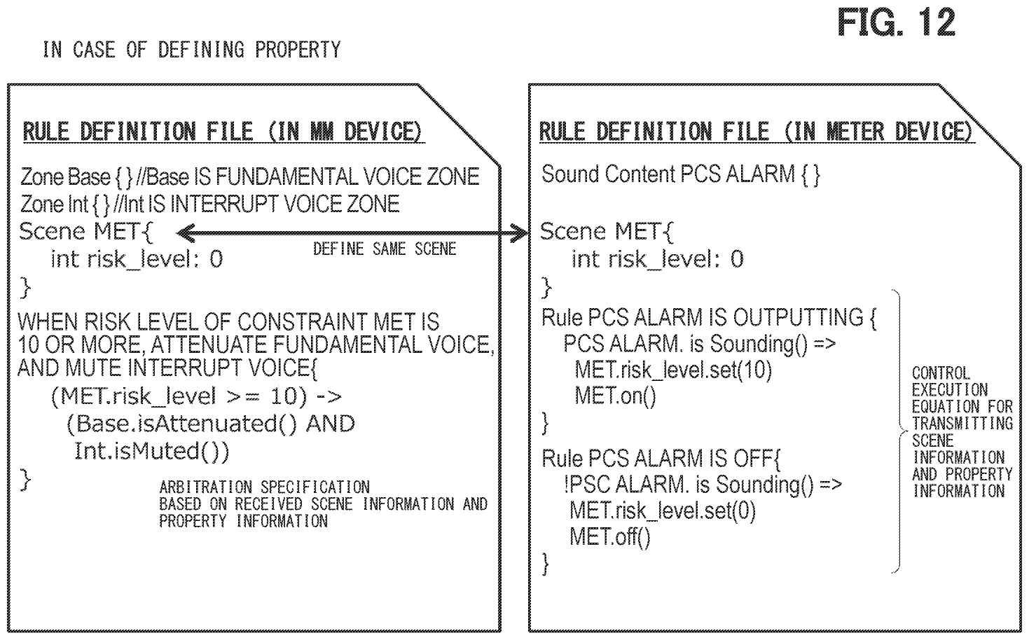

As shown in FIGS. 11 and 12, the rule definition file of the MM device 11 and the rule definition file of the meter device 21 define “Scene MET {}” and define the same scene. When the property is not defined, as shown in FIG. 11, the rule definition file of the meter device 21 defines the control execution equation for transmitting the scene information to the MM device 11. In the rule definition file of the MM device 11, the arbitration specification based on the scene information received from the meter device 21 is defined. When defining the property, as shown in FIG. 12, the rule definition file of the meter device 21 defines the control execution equation for transmitting the scene information and the property information to the MM device 11. In the rule definition file of the MM device 11, the arbitration specification based on the scene information and the property information received from the meter device 21 is defined.

The meter device 21 periodically transmits “no meter sounding” to the MM device 11 in a state where the presentation request is not input from the application X (at t1). When the “presentation request” of the fundamental voice is generated from the application A in the state where the MM device 11 periodically receives “no meter sounding” from the meter device 21 (at t2), the MM device 11 performs arbitration processing (at S1), and outputs “output command” to the application A (at t3), and starts the audio output of the content of the application A.

When the “presentation request” of the interrupt voice is generated from the application B after the voice output by the application A is started (at t4), the MM device 11 performs arbitration processing between the content of the application A and the content of the application B (at S2). When the MM device 11 arbitrates the content of the application B to win and arbitrates the content of the application A to lose, the MM device 11 outputs an “attenuator command” to the application A (at t5), attenuates the audio output of the content of the application A, and outputs “output command” to the application B (at t6), and starts the audio output of the content of the application B.

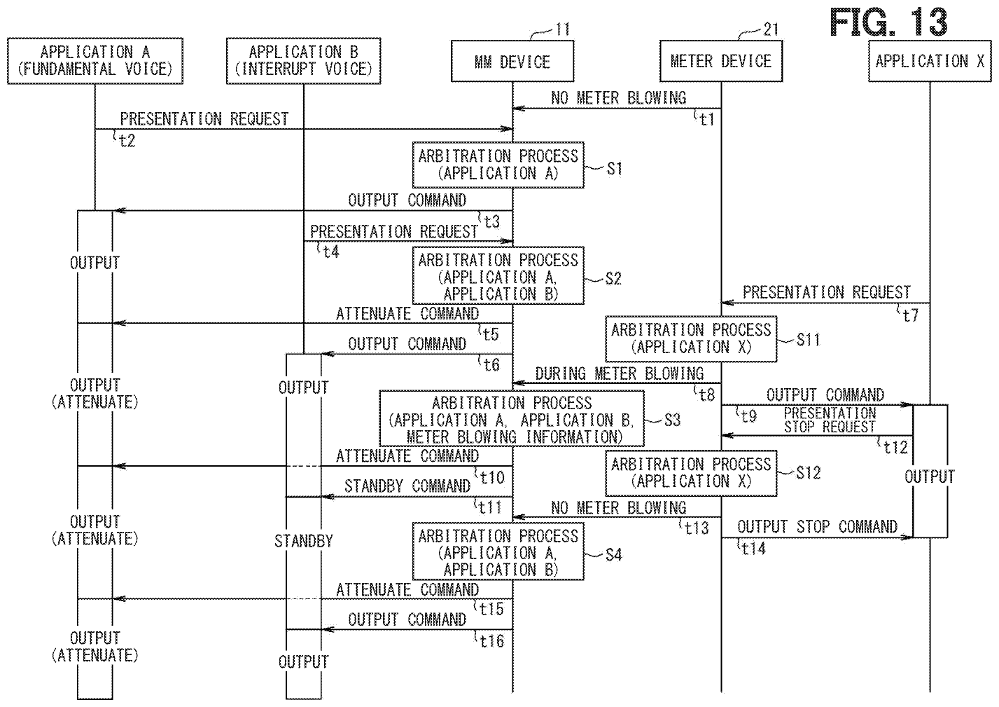

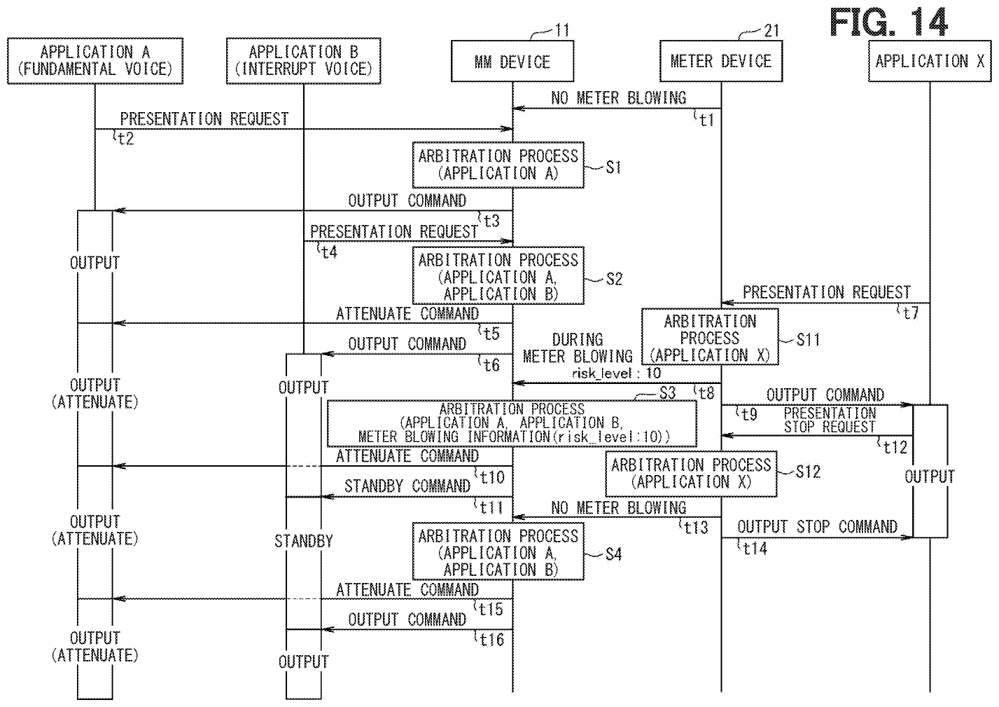

When the “presentation request” of the meter sounding is generated from the application X (at t7), the meter device 21 performs arbitration processing (at S11) and transmits “meter sounding in progress” to the MM device 11 (at t8). In this case, when the property is not defined, the meter device 21 transmits “meter sounding in progress” to the MM device 11 as shown in FIG. 13, and when the property is defined, the meter device 21 transmits “meter sounding in progress” to the MM device 11, as shown in FIG. 14 and further transmits the property information of “risk_level: 10” to the MM device 11. Further, the meter device 21 outputs the “output command” to the application X (at t9), and starts the audio output of the content of the application X.

When the MM device 11 receives “meter sounding in progress” from the meter device 21 (corresponding to the state acquisition procedure and the state acquisition process), the MM device 11 performs an arbitration process (corresponds to the arbitration procedure at S3). When the MM device 11 determines the arbitration win of the meter sounding information and the arbitration loss of the content of the application A and the content of the application B, the MM device outputs an “attenuate command” to the application A (corresponding to the arbitration control procedure and the arbitration control process at t10), maintains the attenuation of the audio output of the content of the application A, outputs the “standby command” to the application B (corresponding to the arbitration control procedure and the arbitration control process at t11), and interrupts and holds the audio output of the content of the application B to be on standby.

When the “presentation stop request” of the meter sounding is generated from the application X (at t12), the meter device 21 performs arbitration processing (at S12) and transmits “no meter sounding” to the MM device 11 (at t13). Further, the meter device 21 outputs the “output stop command” to the application X (at t14), and ends the audio output of the content of the application X.

Upon receiving “no meter sounding” from the meter device 21, the MM device 11 performs arbitration processing (at S4). When the MM device 11 arbitrates the content of the application B to win and arbitrates the content of the application A to lose, the MM device 11 outputs an “attenuator command” to the application A (at t15), maintains to attenuate the audio output of the content of the application A, and outputs “output command” to the application B (at t16), and restarts the audio output of the content of the application B.

By arbitrating in cooperation with the MM device 11 and the meter device 21 in this way, even when a “presentation request” from application A, a “presentation request” from application B, and a “presentation request” from application X are generated at the same time, the audio output of the application X content can be prioritized.

The above has described the case where the MM device 11 receives “meter sounding in progress” from the meter device 21 to acquire the information defined by the rule from the meter device 21, alternatively, the arbitration result of the arbitration performed by the meter device 21 may be obtained from the meter device 21. That is, when the meter device 21 performs the arbitration process between the content of the application X and the content of the application Y, the arbitration result is transmitted to the MM device 11, and when the MM device 11 receives the arbitration result from the meter device 21, the MM device 11 may execute the arbitration process according to the applications A and B and the arbitration result received from the meter device 21.

As described above, the present embodiment can produce the following effects and functions.

In the MM device 11, according to the content presentation request from the applications A and B and the state of the meter device 21, the arbitration is performed to determine to which content is to be presented with priority based on the rule definition. Rather than arbitrating which content is to be presented with priority by itself, the MM device itself and the meter device 21 cooperate with each other to arbitrate therebetween, so that the content having higher priority in the entire system than others can be presented with appropriate priority.

The MM device 11 transmits and receives scene information and property information when arbitrating in cooperation with the meter device 21. By defining property information, various scenes can be expressed, and it is possible to prevent an increase in software development man-hours while suppressing the frequency of changing the communication interface between devices.

Although the present disclosure has been made in accordance with the embodiments, it is understood that the present disclosure is not limited to such embodiments and structures. The present disclosure incorporates various modifications and variations within a scope of equivalents. Additionally, various combinations and configurations, as well as other combinations and configurations including more, less, or only a single element, are within the scope and spirit of the present disclosure.

It may be applied not only to the vehicle but also to the content presentation control device for purposes other than the vehicle. In the MM device 11, the case where the content presentation request from the applications A and B and the state of the meter device 21 are arbitrated has been illustrated, alternatively, the situation of the MM device 11 and the situation of the meter device 21 may be replaced. That is, in the meter device 21, the content presentation request from the applications X and Y and the state of the MM device 11 may be arbitrated.

The controllers and methods thereof described in the present disclosure in the above embodiments may be implemented by one or more than one special-purpose computer. Such a computer may be created (i) by configuring (a) a memory and a processor programmed to execute one or more particular functions embodied in computer programs, or (ii) by configuring (b) a processor provided by one or more special purpose hardware logic circuits, or (iii) by configuring a combination of (a) a memory and a processor programmed to execute one or more particular functions embodied in computer programs and (b) a processor provided by one or more special purpose hardware logic circuits. The computer program may be stored, as an instruction executed by a computer, in a computer-readable non-transitory tangible storage medium. Alternatively, the control unit and the method according to the present disclosure may be achieved by a dedicated computer provided by constituting a processor with one or more dedicated hardware logic circuits. Alternatively, the control unit and the method according to the present disclosure may be achieved using one or more dedicated computers constituted by a combination of the processor and the memory programmed to execute one or more functions and the processor with one or more hardware logic circuits. The computer program may also be stored on a computer readable non-transitory tangible recording medium as instructions to be executed by a computer.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A content presentation control device comprising:
an application storage unit that stores an application for generating a presentation request of a content;
a rule definition storage unit that stores a rule definition including a constraint equation;
a state acquisition unit that acquires a state of an external device;
an arbitration unit that arbitrates which content is preferentially presented, based on the rule definition stored in the rule definition storage unit according to the presentation request from the application and the state of the external device acquired by the state acquisition unit; and
a presentation control unit that controls a presentation of the content according to an arbitration result performed by the arbitration unit.

2. The content presentation control device according to claim 1, wherein:
the state acquisition unit acquires information defined by a rule in the external device as the state of the external device.

3. The content presentation control device according to claim 1, wherein:
the state acquisition unit acquires the arbitration result obtained by arbitrating in the external device as the state of the external device.

4. The content presentation control device according to claim 1, wherein:
the state acquisition unit acquires scene information as the state of the external device.

5. The content presentation control device according to claim 1, wherein:
the state acquisition unit acquires scene information and property information as the state of the external device.

6. The content presentation control device according to claim 1, further comprising:
one or more processors; and
a memory coupled to the one or more processors and storing program instructions that when executed by the one or more processors cause the one or more processors to provide at least: the state acquisition unit; the arbitration unit; and the presentation control unit.

7. A presentation control method for a content comprising:
acquiring a state of an external device;
arbitrating which content is preferentially presented, based on a rule definition including a constraint equation according to a presentation request of the content obtained from an application and the state of the external device acquired in the acquiring of the state; and
controlling a presentation of the content according to an arbitration result performed in the arbitrating.

8. A non-transitory tangible computer readable storage medium comprising instructions being executed by a computer, the instructions including a computer-implemented method for displaying a three-dimensional image on a display, the instructions including:
acquiring a state of an external device;
arbitrating which content is preferentially presented, based on a rule definition including a constraint equation according to a presentation request of the content obtained from an application and the state of the external device acquired in the acquiring of the state; and
controlling a presentation of the content according to an arbitration result performed in the arbitrating.
